(19) United States
(12) Patent Application Publication
(10) Pub. No.: US 2004/0237751 A1
(43) Pub. Date: Dec. 2, 2004

(54) Bow guide for a stringed instrument

(76) Inventor: Roger Foxwell, Heald Green (GB)

Correspondence Address: DENNISON, SCHULTZ, DOUGHERTY & MACDONALD, 1727 KING STREET, SUITE 105, ALEXANDRIA, VA, 22314, US

(21) Appl. No.: 10/849,173

(22) Filed: May 20, 2004

(30) Foreign Application Priority Data
May 29, 2003 (GB) 0312272.8
Nov. 13, 2003 (GB) 0326441.3

(51) Int. Cl. G10D 1/02

(52) U.S. Cl. 84/283

(57) ABSTRACT

A bow guide for a violin is made from resilient material, such as a unitary piece of foamed plastics, and comprises a support means for elastically securing under the overhang of the fingerboard and upstanding guide means protruding in use upwards from ends of the support means so as to guide a bow in a desired region of the strings. One, two or four guide means are possible, two being preferred.

### FIELD OF THE INVENTION

The present invention relates to a bow guide for use with a stringed musical instrument of the violin school (i.e. violin, viola, violin cello and double bass), in particular to a bow guide for aiding an instrumentalist to practice using a bow perpendicular to the strings.

### BACKGROUND OF THE INVENTION

A known problem in teaching a beginner to play a stringed instrument, such as a violin, is to ensure that the student moves their bow across the strings perpendicular to the direction of the strings. In addition the student may also place their bow, or let their bow slide, away from a desired position along the length of the strings between the end of a fingerboard and abridge over which the strings pass.

To help students and more experienced players correct these problems with bowing a wide variety of bow guides have been proposed. The principal effect of such devices is to physically restrain the possible movement of a bow across the strings, such as by means of bars, frames and the like. However, such means risk for the beginner damaging the bow by contacting the bow with the guide and for the more experienced user damaging the bow by, for example, forgetting a bow guide is present.

Furthermore known bow guides are attached to an instrument by various forms of direct clamping. Such clamping can significantly alter the resonance of the instrument and can potentially damage the instrument, particularly when screw clamps are used.

The physical mass of a bow guide can also act to alter resonance and even unbalance an instrument, as perceived by an experienced player.

### OBJECTS OF THE INVENTION

Objects of the present invention include the provision of a bow guide with a reduced risk of damaging an instrument or a bow, with minimal effect on instrument sound production and of a lightweight, simple and cost effective construction.

### SUMMARY OF THE INVENTION

The present invention provides a stringed instrument bow guide which predominantly comprises a resilient material and which includes compressible support means adapted for insertion under a fingerboard of a stringed instrument and one or more guide means upstanding from the support means.

The use of a resilient material, such as a cellular foamed plastics material, greatly reduces the risk of abrasion of an instrument or of a bow. In addition such a bow guide is lightweight. When the bow guide is of unitary/one-piece construction it is simple and inexpensive to manufacture. In this respect, preferred embodiments are envisaged as being made exclusively from or nearly entirely from the resilient material.

The support means of a bow guide according to the invention is preferably of greater thickness than a gap between the overhang of a fingerboard and the soundboard of a stringed instrument so that, in use, the bow guide may be attached by compressing the support means, placing it into the overhang and releasing it. The support means expands to fill the gap between the fingerboard and the soundboard and so retains the bow guide in place without requiring the use of nuts, bolts, clips, clamps and the like.

Alternatively, or in addition, the bow guide may have two extensions from the support means (e.g. constituted by the guide means or part of the guide means) which have a spacing therebetween which is a spacing which is less than the width of the fingerboard where it overhangs the sound board. To attach the bow guide it is placed under the strings between the bridge and the fingerboard, the extensions are then stretched apart before placing the bow guide into the overhang and releasing it. The support means contracts to bring the extensions towards each other and against either side of the fingerboard and so as to retain the bow guide in place without requiring the use of nuts, bolts, clips, clamps and the like.

By the optional combined provision of the above two retention mechanisms a bow guide of the invention of a given size is readily able to be attachable, in use, to various instruments of different sizes, for example various violins, as at least one of the mechanisms is likely to be effective.

Advantageously bow guides of the invention have no moving parts, i.e. parts that would require manufacturing steps or may wear out.

In a preferred embodiment of the invention the bow guide is a unitary piece of low-density foamed plastics of rectangular cross-section. Such a bow guide may be cut from a single piece of plastics foam, such as foam rubber, polyurethane etc., using known techniques, for example, cutting with a knife, water-jet and laser cutting. Such a unitary bow guide may comprise two substantially parallel guide means projecting laterally and substantially perpendicularly at opposing ends of the support means. In other words it may be of angular U shape or channel shape profile.

Use of a highly deformable resilient material, such as a foamed plastic, for a bow guide may enable an instrument equipped with such a bow guide to be stored in a case without having to remove or adjust the bow guide.

### BRIEF DESCRIPTION OF DRAWINGS

The invention will be described further, by way of example, with reference to the accompanying drawings, in which;

FIG. 1 is an end view of a preferred embodiment of a bow guide of the invention;

FIG. 2 is a perspective view of the bow guide of FIG. 1; and

FIG. 3 is a perspective view showing the bow guide of FIG. 1 mounted, in use, on a violin.

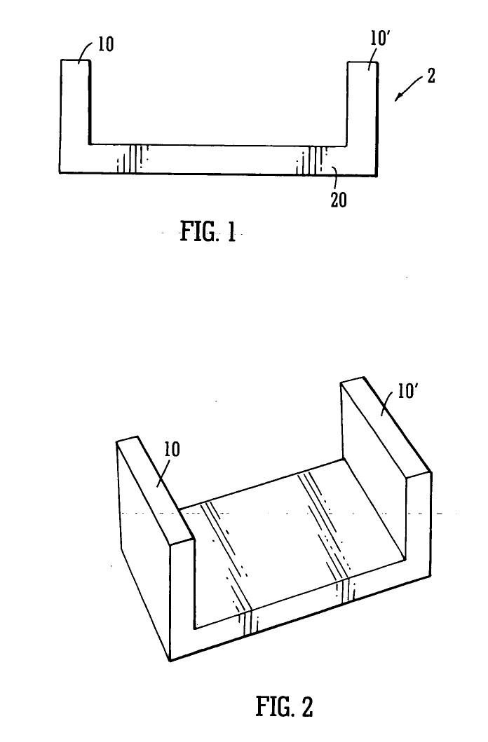

### DETAILED DESCRIPTION OF PREFERRED EMBODIMENTS

As shown, a practical embodiment of a bow guide 2 according to the invention comprises a unitary structure (i.e. a pad) made from plasticised polyurethane foam with a support means in the form of a base 20, from each side of which protrudes at a right angle respective guide means in the form of two wings 10, 10′. The foamed plastics material used is of a quality akin to that normally used in furniture cushions. The bow guide 2 is of an angular U-shaped cross-section.

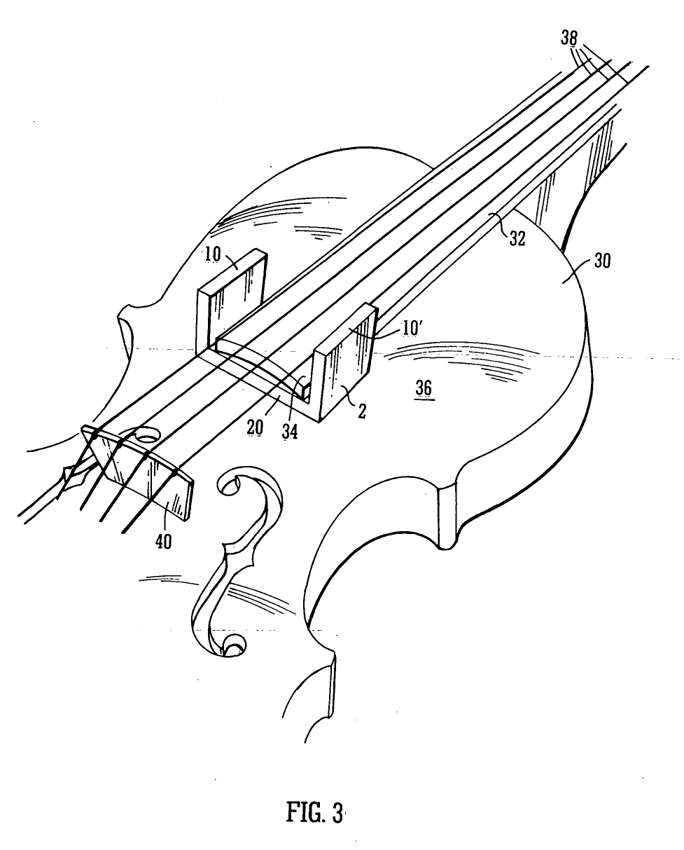

In use the bow guide 2 is placed on a violin 30 as shown in FIG. 3. Base 20 is located under an end 34 of the fingerboard 32 where the fingerboard overhangs the soundboard 36. The base 20 is made to be deeper than the overhang of the fingerboard so that it is necessary to compress the base 20 to fit it under the overhang. Resilient expansion of the foamed plastics therefore serves to secure the bow guide on the violin.

In use the wings 10, 10′ protrude above the level of the strings 38 and on either side of the outermost of those strings 38. Due to the non-restrictive position and material of the guide 2 a player is not restricted in the playing of music. Use of a bow on the strings 38 in conventional manner is not constrained. However, should the bow be misplaced the bow may abut one or both of the wings 10, 10′ to restrain bow movement. The player will sense this by a slight resistance to bow movement. If a hard, i.e. unplasticised, foamed plastic is used an audible sound may also be created by the bow on the foam. The player is thereby given feedback to enable them to correct his/her technique. In addition the resilient interaction of the wings with a bow protects the bow from damage.

In an alternative embodiment of the invention (not shown) wings may be provided for use at one side of the strings to define a length of the strings over which the bow may be used. In use such an embodiment is secured under the fingerboard in a manner similar to that previously described. At least one wing is near the end of the fingerboard and another further toward the bridge 40 of the instrument so as to define a required length of strings 38 over which a bow is to be used.

In further alternative embodiments only one wing may be provided. This wing may be variously constructed for location on either side of the fingerboard. Advantageously a single L-shaped member may be useable in either position. Another possibility is to have a guide member offset so as to be locatable adjacent the bridge by a support means extension portion attached to a main support means portion locatable as described above. In such embodiments a low retaining extension may be provided to enable the alternative securing method, as described above, as no second guide means is present to fulfil the function of allowing attachment by an ‘extension’ as described.

Devices of the invention may be varied from those described above by normal workshop variations. For example, a bow guide with four mutually parallel wings upstanding from a base may be used, the wings defining four corners of a region of the strings between the end of the fingerboard and the bridge.

1. A stringed instrument bow guide which predominantly comprises a resilient material and which includes compressible support means adapted for insertion under a fingerboard of a stringed instrument and at least one guide means upstanding from the support means.

2. A bow guide as set forth in claim 1 wherein the resilient material is a foamed plastics material or a cellular material.

3. A bow guide as set forth in claim 2 wherein the material is a plasticised polyurethane foam.

4. A bow guide as set forth in claim 1 wherein the support means is, in use, securable under the fingerboard by being extended, under tension, laterally across the fingerboard.

5. A bow guide as set forth in claim 1 wherein the guide means is substantially perpendicular to the support means.

6. A bow guide as set forth in claim 1 wherein two guide means are present.

7. A bow guide as set forth in claim 6 wherein the guide means are so arranged relative to the support means that, in use, at least one guide means is upstanding on either side of the fingerboard.

8. A bow guide as set forth in claim 1 wherein the support means is rectangular in cross-section.

9. A bow guide as set forth in claim 1 wherein the or each guide means is rectangular in cross-section.

10. A bow guide as set forth in claim 1 which is of unitary construction.
